(19) United States
(12) Patent Application Publication
(10) Pub. No.: US 2026/0193858 A1
(43) Pub. Date: Jul. 9, 2026

(54) Debris Shield Mesh

(71) Applicant: FLOODBREAK, L.L.C., Bellaire, TX (US)

(72) Inventors: Louis A. Waters, JR., Bellaire, TX (US); Nick A. Eastman, Georgetown, TX (US)

(21) Appl. No.: 19/439,320

(22) Filed: Jan. 3, 2026

Related U.S. Application Data
(60) Provisional application No. 63/742,495, filed on Jan. 7, 2025.

(51) Int. Cl. E02B 3/10; A46B 5/00; B08B 1/16; B08B 1/30; B65H 75/44; B65H 75/48

(52) U.S. Cl. CPC E02B 3/104; A46B 5/0004; B08B 1/165; B08B 1/30; B65H 75/4402; B65H 75/486; A46B 2200/3073

(57) ABSTRACT

A flood barrier flip-up panel in a horizontal housing has a debris shield mesh as wide as the panel. The mesh openings allow water to flow freely through the mesh but not debris of a size larger than the openings. One end of the mesh is attached to a fixture of the same width either (1) in the front end of the housing or (2) in a front end of the panel. The opposite end of the shield is attached respectively either to a roller of the same width rolling in the front end of the panel or to a roller in the front end of the housing. When the panel is resident in the housing, the mesh wraps around the roller. When the panel rotates from the housing, the mesh unrolls from the roller.

### CROSS REFERENCE TO RELATED APPLICATION

This application claims the benefit of U.S. Provisional Application 63/742,495 filed Jan. 7, 2025 and titled “DEBRIS SHIELD MESH.” U.S. Provisional Application 63/742,495 is hereby fully incorporated by reference as if set forth fully herein.

### BACKGROUND OF THE INVENTION

U.S. Pat. No. 9,279,224 by one of the inventors of the present invention describes a passive self-erecting system involving buoyant metal panels extending over water and rotating upward between flanking permanent end walls to form a floodwater barrier. U.S. Pat. No. 9,458,590 also by the same inventor describes a plurality of linked buoyant panels rotating upward between flanking permanent end walls to form a floodwater barrier. A more recent U.S. patent by such inventor is U.S. Pat. No. 10,619,317 respecting flood barrier panel assemblies on land near a water frontage shoreline that have panels mechanically actively erectable into a continuous barrier preventing flooding of the land. These buoyant or mechanically erectable kinds of panels are generically called “flip-up” panels. The panels are typically hingedly recumbent in a generally horizontal housing from which they rotate upward.

When flip up panels rotate upward to provide a flood barrier, water trapped behind the barrier may carry water borne debris that gets into the housing for the panels, sometimes necessitating an operation to remove the debris from the housing after the flood event so it doesn't interfere with the future operation of the panels.

### BRIEF SUMMARY OF THE INVENTION

This invention relates to flip-up panel flood barriers in which a debris shield mesh substantially the width of the panel is automatically deployed when the panel rises and is automatically retracted when the panel lowers. The debris shield mesh has mesh openings so porous as to allow water to flow freely through the mesh but not debris of a size larger than the mesh openings. The invention is probably most useful for individual flip-up flood barriers in environments which will naturally produce lots of flood-borne debris such as rivers, dry drainage ditches, and remote reaches of a flood control project although it may be useful as well in a plurality of flip-up panels that form raisable flood barriers to prevent flooding of land and improvements on the land by water rising from an adjacent body of water without permanently blocking a view of an often-attractive waterscape.

### BRIEF DESCRIPTION OF THE DRAWINGS

In the following detailed description of exemplary embodiments, reference is made in some embodiments to the accompanying drawings, which form a part hereof and in which are shown by way of illustration non-limiting embodiments by which the invention may be practiced. Certain features of the invention are shown in exaggerated scale or in somewhat schematic form and in some drawings some details of elements shown in other drawings are omitted in the interest of clarity and conciseness. Referring to the drawings:

FIG. 1 depicts in isometric view of the top of a single panel in horizontal repose between a pair of upright walls fixed to land.

FIG. 2 depicts a cross sectional view the panel of FIG. 1 in repose in a support housing having front and back sides and situated in land between the pair of upright walls (in cross section the lateral wall facing the viewer is not seen).

FIG. 3 depicts an enlarged portion of FIG. 2 showing one end of a debris shield mesh attached to a fixture on the interior of the front side of the support housing and the other end attached to a roller rotating on a first horizontal axle mounted in an inset of the front end of the panel.

FIG. 4 is an isometric view of the panel shown in cross section in FIG. 2 showing one end of a debris shield mesh attached to a fixture on the interior of the front side of the support housing and the other end attached to a roller rotating on a first horizontal axle mounted in an inset of the front end of the panel. The views of FIGS. 4-8 are oriented 180 degrees from the views of FIGS. 1-3.

FIG. 5 is an enlargement of the left portion of FIG. 4.

FIG. 6 is an isometric view of a partial rise of the panel of FIGS. 1-5 rising out of the support housing of FIGS. 2-5. (The lateral side wall of the support housing is removed to show interior structure of the apparatus.) The panel may be buoyant initially to rise under the influence of water admitted into the support housing then rising further under the influence of hydrostatic pressure also on the bottom side of the panel as in U.S. Pat. Nos. 9,279,224 and 9,458,590 mentioned above, or alternatively the panel is mechanical erectable upwardly out of the support housing as in U.S. Pat. No. 10,619,317 mentioned above. In the drawings the panel is to be understood buoyant, omitting from the drawings mechanical means for raising the panels in the interest of clarity and conciseness.

FIG. 7 is an isometric view of the panel of FIGS. 1-6 risen out of the support housing of FIGS. 2-6 to a fully upright position. A portion of the debris shield mesh of FIG. 7 is removed to reveal structure behind the debris shield mesh.

FIG. 8 is the same view as FIG. 1 but showing the fully risen panel with the debris shield mesh fully extended.

The views of FIGS. 9-11 are oriented in the same direction as the views of FIGS. 1-3.

FIG. 9 is a cross-sectional view of the fully risen panel and debris shield mesh of FIGS. 1-8.

FIG. 10 is an enlargement of the end of the debris shield mesh attaching to the fixture on the interior of the front side of the support housing of FIGS. 1-8.

FIG. 11 is an enlargement of the end of the debris shield mesh attaching to the roller rotating on a horizontal axle mounted in an inset of the front end of the panel of FIGS. 1-8.

FIG. 12 is a partially sectional view of the top roller of the fully risen panel of FIGS. 3-8.

FIGS. 13, 14,15 are the same views as FIGS. 1, 2 and 3 but showing a second roller mounted under the fixture to which one end of the debris shield mesh is attached, the other end being attached to the roller seen in FIGS. 2-12 (the “first roller”).

FIGS. 16, 17, 18 and 19 are substantially the same views as FIGS. 4, 5, 6, and 7 but showing the second roller of FIGS. 13, 14 and 15. A portion of the debris shield mesh of FIGS. 18 and 19 is removed to reveal structure behind the debris shield mesh.

FIGS. 20 and 21 are substantially the same views as FIGS. 14 and 15 but showing a third roller rotating on a third horizontal axle mounted in an inset of the front end of the panel.

FIGS. 22, 23, and 24 are substantially the same views as FIGS. 17, 18 and 19 but show a support attached to the front end of the panel supporting a brush wiper having a width substantially the same as the width of the panel, the wiper having upper and lower brushes through which the debris shield mesh passes and also showing the third roller of FIGS. 20, 21. A portion of the debris shield meshes of FIGS. 23 and 24 is removed to reveal structure behind the debris shield meshes.

FIG. 25 is substantially the same view as FIG. 9 and depicts a portion outlined in the upper left corner that is enlarged as FIG. 26.

FIG. 26 is substantially the same view as FIG. 11 and shows an enlargement of the first and third rollers and the upper and lower brushes of the wiper and wiper support.

FIG. 27 is substantially the same view as FIG. 8 for the embodiment depicted in FIGS. 20-26.

FIG. 28 is substantially the same view as FIG. 12 and is a top view of the fully risen panel showing first roller of FIGS. 20-26 partially in section.

FIG. 29 depicts an embodiment in which the end of the debris shield mesh attached to a roller is a roller rotating on an axle in the interior of the front end of the housing and the opposite end of the debris shield mesh attaches to a fixture at the front end of the panel.

### DETAILED DESCRIPTION OF EMBODIMENTS OF THE INVENTION

In accordance with this invention, a debris shield mesh substantially the width of a flip-up panel has mesh openings so porous as to allow water to flow freely through the mesh but not debris of a size larger than the mesh openings and is automatically deployed when the panel rotates out of horizontal housing for the panel and is automatically retracted when the panel rotates into the housing.

Specific details described herein, including what is stated in the Abstract, are in every case a non-limiting description and exemplification of embodiments representing concrete ways in which the concepts of the invention may be practiced. This serves to teach one skilled in the art to employ the present invention in virtually any appropriately detailed system, structure or manner consistent with those concepts. Reference throughout this specification to “an exemplary embodiment” means that a particular feature, structure, or characteristic described in connection with the embodiment is included in at least one exemplary embodiment of the present invention. Thus, the appearances of the phrase “in an exemplary embodiment” or similar expression in various places throughout this specification are not necessarily all referring to the same embodiment. Further, the particular features, structures, or characteristics may be combined in any suitable manner in one or more embodiments. Various changes and alternatives to the specific described embodiments and the details of those embodiments may be made within the scope of the invention. One or more of the elements depicted in the drawings can also be implemented in a more separated or integrated manner, or even removed or rendered as inoperable in certain cases, as is useful in accordance with a particular application. Because many varying and different embodiments may be made within the scope of the inventive concepts herein described and in the exemplary embodiments herein detailed, it is to be understood that the details herein are to be interpreted as illustrative and not as limiting the invention to that which is illustrated and described herein.

The various directions such as “upper,” “lower,” “back,” “front,” “vertical”, “upright”, “horizontal,” “length,” “laterally”, “proximal”, “distal” and so forth used in the detailed description of exemplary embodiments are made only for easier explanation in conjunction with the drawings. The components may be oriented differently while performing the same function and accomplishing the same result as the exemplary embodiments herein detailed embody the concepts of the invention, and such terminologies are not to be understood as limiting the concepts which the embodiments exemplify. The terms “horizontal” or “horizontally” include but are not limited to literal horizontal and generally mean not out of level with respect to immediately adjacent land to a degree that will materially adversely affect the function of the element described as horizontal. Similarly, the terms “vertical” or “upright” include but are not limited to literal vertical and generally mean substantially up and down with respect to immediately adjacent land to a degree that will not materially adversely affect the function of the element described as vertical or upright.

As used herein, the terms “comprises,” “comprising,” “includes,” “including,” “has,” “having” or any other variation thereof, are intended to cover a non-exclusive inclusion. For example, apparatus that comprises a list of elements is not necessarily limited to only those elements but may include other elements not expressly listed or inherent to such apparatus. Further, unless expressly stated to the contrary, as indicated by “either” preceding “or” in the same sentence, “or” refers to an inclusive or and not to an exclusive or. That is, unless otherwise indicated, the term “or” is generally intended to mean “and/or”. For example, a condition A or B is satisfied by any one of the following: A is true (or present) and B is false (or not present), A is false (or not present) and B is true (or present), and both A and B are true (or present).

As used herein, the use of the word “a” or “an” when used in conjunction with the term “comprising” (or the synonymous “having” or “including”) in the claims and/or the specification may mean “one,” but it is also consistent with the meaning of “one or more,” “at least one,” and “one or more than one.” In addition, as used herein, the phrase “connection to” or “connected to” means joined to, either directly or through intermediate components.

Exemplary apparatus embodiments of the invention comprise at least one flip up flood barrier assembly arranged on land near a waterway. The word “waterway” may mean rivers, dry drainage ditches, remote reaches of a flood control project, an adjacent body of water, or land subject to sheet flooding. Each assembly comprises a substantially horizontal support housing situated in or on the land and having front and back sides and a panel having a top surface, a bottom surface, a front end, a back end, and lateral sides of a length that runs from the back end to at least near the front end of the panel, the panel residing in the support housing in a lowered position in which the lateral sides have an imagined projected intersecting angle to the waterway, the lateral sides defining between them the width of the panel, the panel being hinged at the back end of the panel to an interior of the back side of the support housing to rotate upwardly from the housing to an upright raised position where invading flood water will be contained at the bottom surface of the panel. This hinging detail is omitted in all the drawings in the interest of clarity and conciseness but is to be understood as present. For examples of hinging details reference is made to the U.S. Patents cited above under the topic “Background of the Invention.”

In an exemplary embodiment, the assembly further comprises a debris shield mesh having mesh openings so porous as to allow water to flow freely through the mesh but not debris of a size larger than the mesh openings, the debris shield mesh having opposite ends and a width substantially as wide as the width of the panel, in a first instance one end of the debris shield mesh attaches to a fixture in an interior of the front side of the support housing, this fixture having substantially the same width as the debris shield mesh, and the opposite end of the debris shield mesh attaches to a roller rotating on a horizontal axle mounted in the interior of the front end of the panel, and in an alternative second instance one end of the debris shield mesh attaches to a roller rotating on a horizontal axle in the interior of the front end of the housing, this roller having substantially the same width as the debris shield mesh, and the opposite end of the debris shield mesh attaches to a fixture at the front end of the panel, this fixture having substantially the same width as the debris shield mesh.

In an exemplary embodiment, in either of such first or second instances, the debris shield mesh further comprises self-winding means linked to the horizontal axle, the self-winding means winding up when the panel rotates upwardly to the upright raised position, such means exerting unwinding force in the opposite direction of the winding up direction when the panel lowers to the support housing, the self-winding means controlling unwrapping and wrapping of the debris shield mesh on the first roller when the panel rises and lowers, whereby the debris shield mesh is automatically deployed when the panel rises and is automatically retracted when the panel lowers.

In an exemplary embodiment the self-winding means comprises a torsion spring coiled around the first horizontal axle, the spring twisting about the axis of the coil when the panel rotates upwardly to the upright raised position, the spring exerting torque in the opposite direction of the twist when the panel lowers to the support housing.

In an exemplary embodiment of the first of the aforementioned alternatives the aforesaid fixture is a bracket on an interior of the front side of the support housing and the aforesaid roller is a first roller that rotates on a first horizontal axle mounted in the interior of the front end of the aforesaid panel. The first alterative further comprises a second roller rotating under the bracket on a second horizontal axle attached to the bracket. The debris shield mesh passes under the second roller to aid in reducing any shearing of the debris shield mesh as the panel rotates upwardly from the housing to an upright raised position unwrapping a substantial part of the debris shield mesh from said first roller.

In an exemplary embodiment, a wiper support is attached to the front end of the panel, the support supporting a wiper having a width substantially the same as the width of the panel for wiping debris off the debris shield mesh before the debris shield mesh is rewound onto the first roller. The wiper may be a scraper, a brush, or may be upper and lower brushes through which the debris shield mesh passes, the upper brush wiping the top side of the debris shield mesh and the lower brush wiping the underside of the debris shield mesh.

In an embodiment in which the wiper comprises the upper and lower brushes, a curved surface having a substantially similar length as the aforementioned first roller is located between the wiper and the first roller to keep the width of the debris shield mesh centered between the brushes regardless of the diameter of the first roller when it changes diameter as more or less debris shield mesh material is wraps or unwraps around it.

In an exemplary embodiment the aforesaid curved surface is a third roller rotating on a third horizontal axle mounted at an interior of the front end of the panel under the first roller.

In a debris shield mesh exemplary embodiment, the panel is buoyant and the support housing for the panel allows invading water to enter the housing to buoy the panel upwardly out of the housing.

In a debris shield mesh exemplary embodiment, the panel is mechanically raisable upwardly out of the housing.

In a debris shield mesh exemplary embodiment, the panel is both mechanically raisable upwardly out of the housing and is also buoyant and the support housing allows invading water to enter the housing to buoy the panel upwardly out of the housing.

In a debris shield exemplary embodiment, the panel has a plurality of retention members having top and bottom ends, the top end attaching to the bottom surface of the panel and the bottom end attaching to the support pan, each retention member extending as the panel rotates upwardly out of the support housing to prevent the panel from rotating past the upright raised position.

In a debris shield exemplary embodiment, the panel is centered between a pair of upright walls, each of which is fixed next adjacent a lateral side of the panel, each wall having a contact surface as tall as the lateral side of the adjacent panel when the panel is in the upright raised position, the lateral side of the panel next adjacent the wall attaching a gasket for sealing contact with the contact surface of the wall.

In a debris shield exemplary embodiment, a plurality of panels is recumbent in a support housing between upright walls. The panels on rotation out of the housing to an upright raised position form a continuous barrier against rising waters flooding land beyond the top surfaces of the panels.

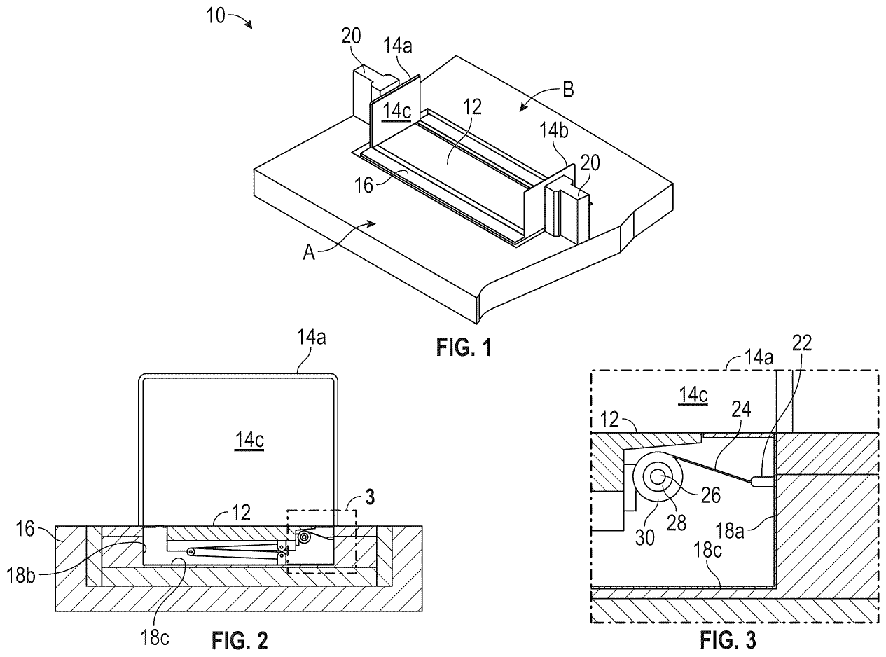

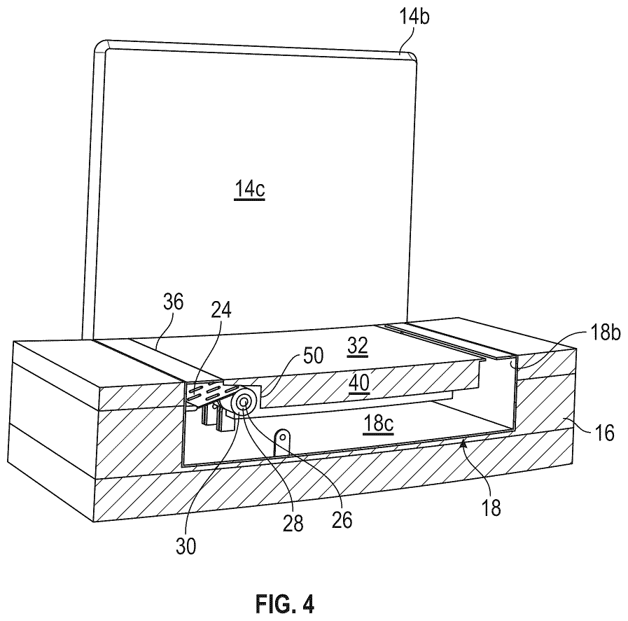

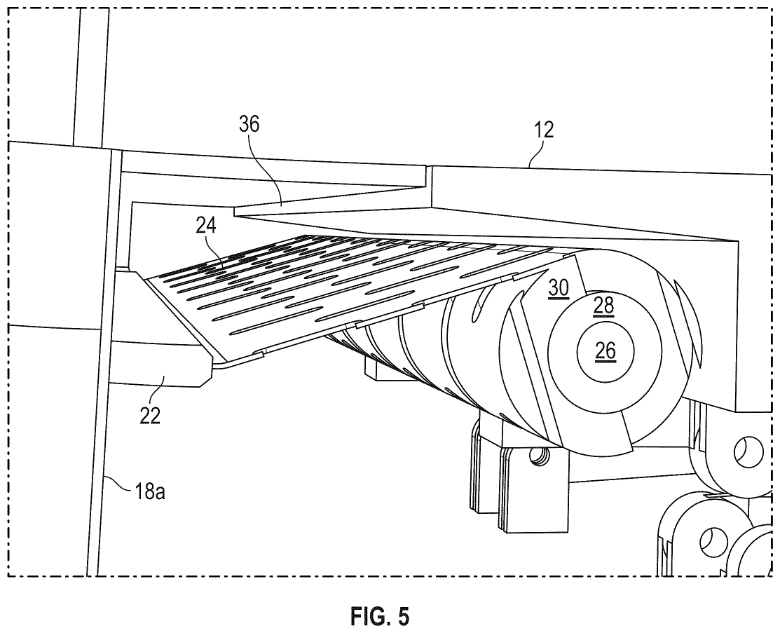

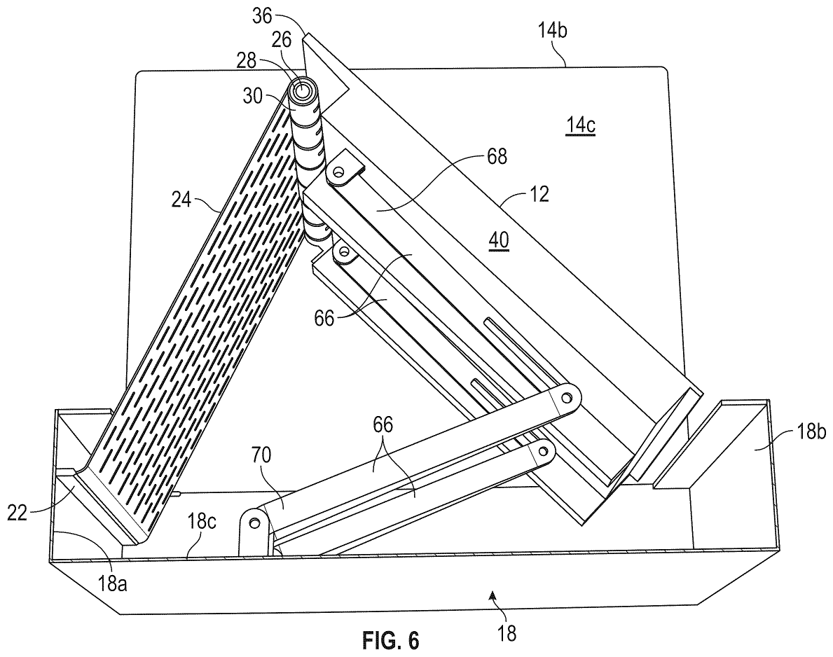

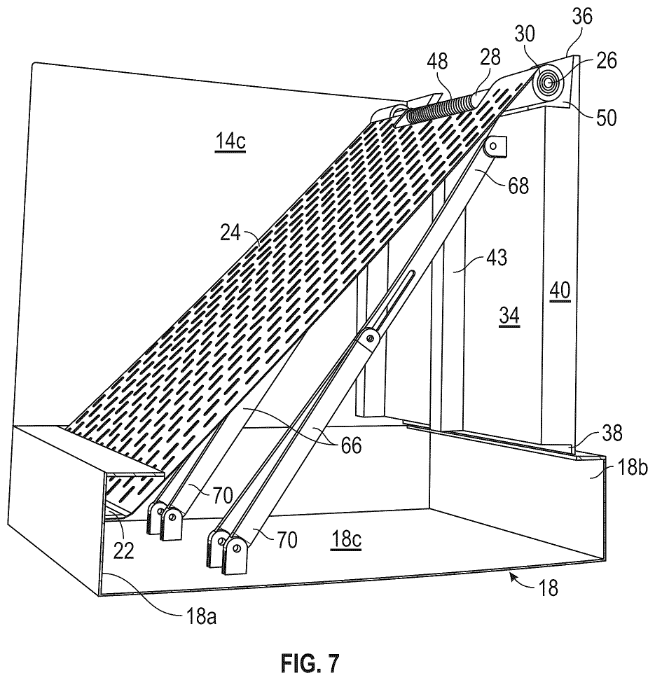

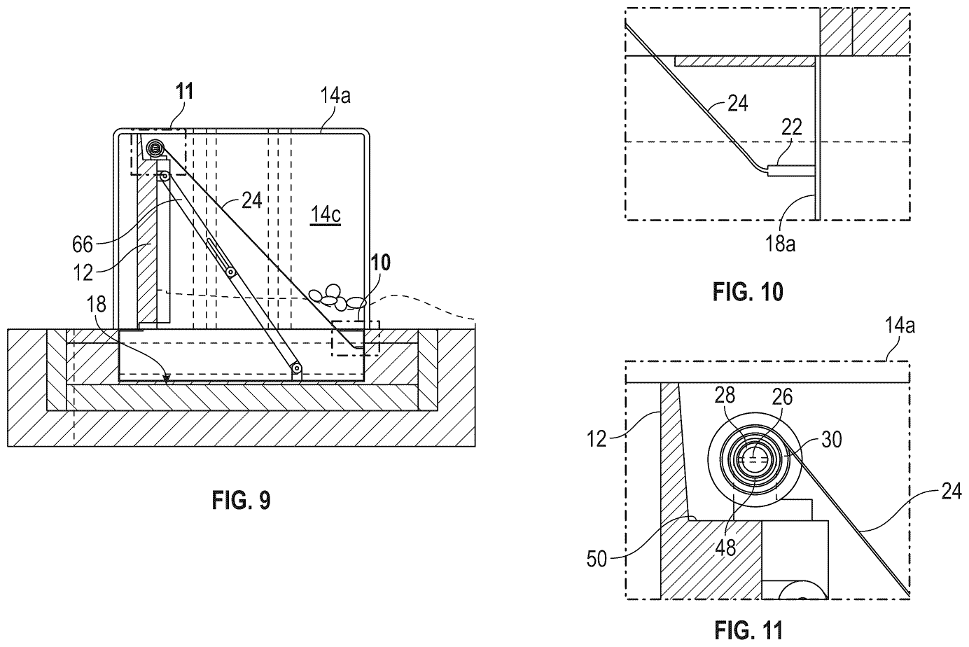

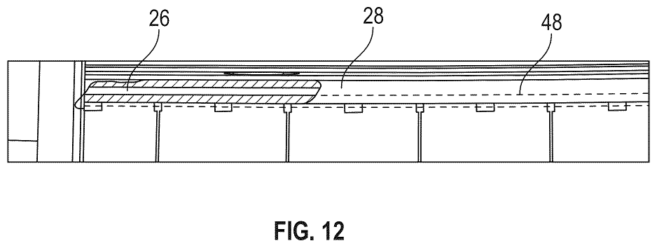

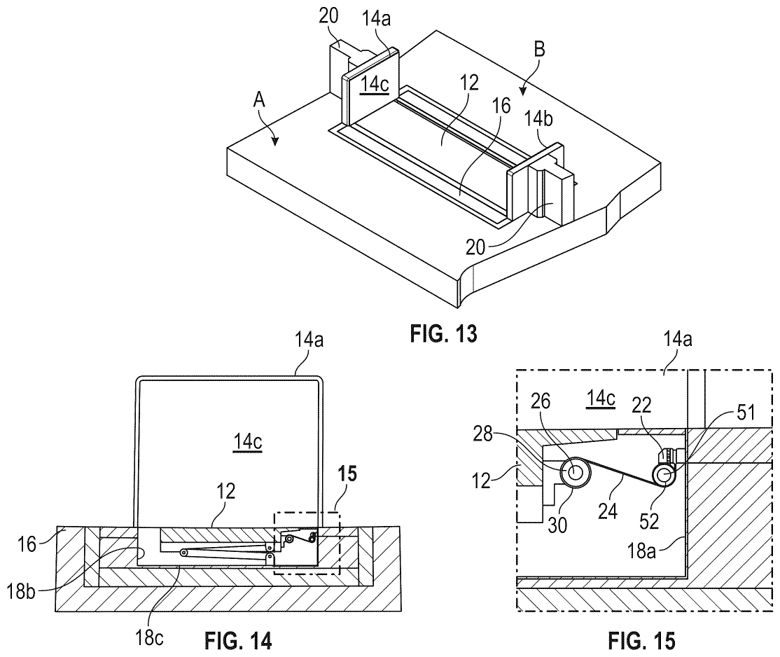

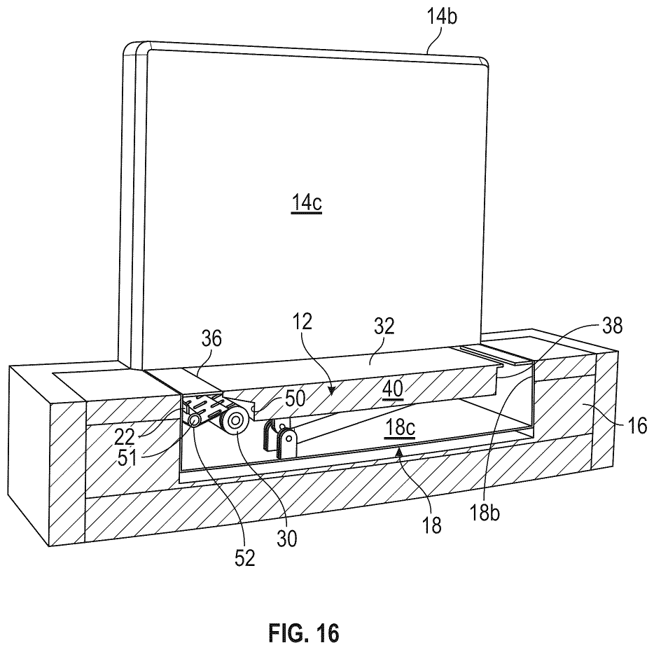

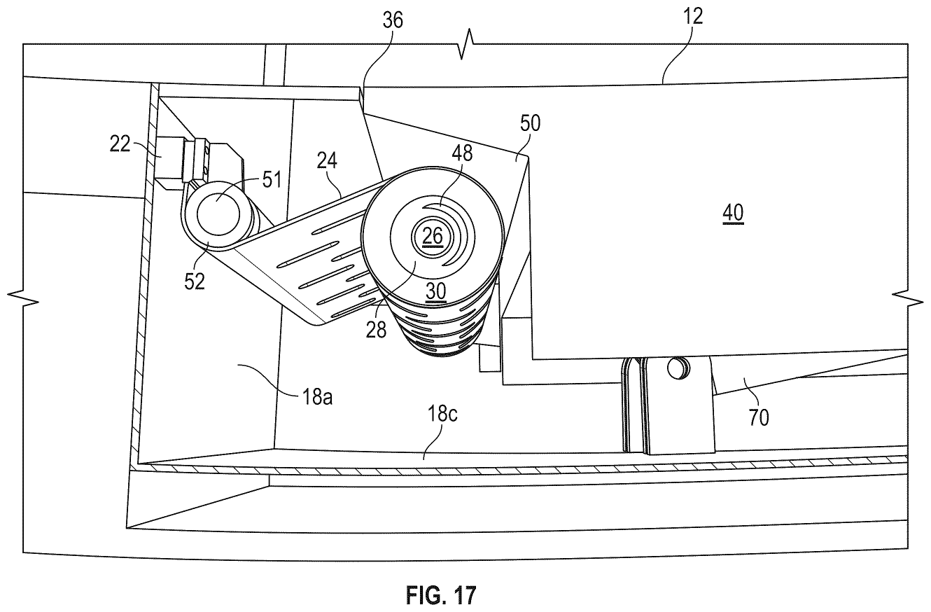

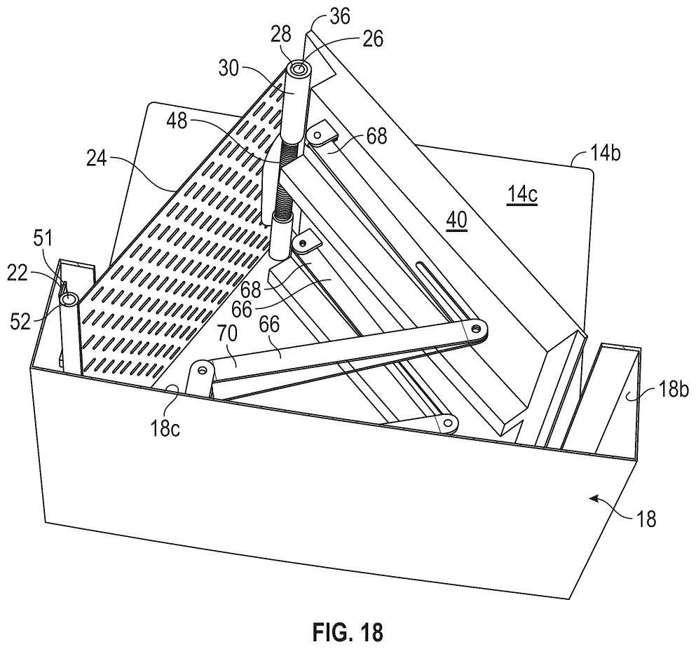

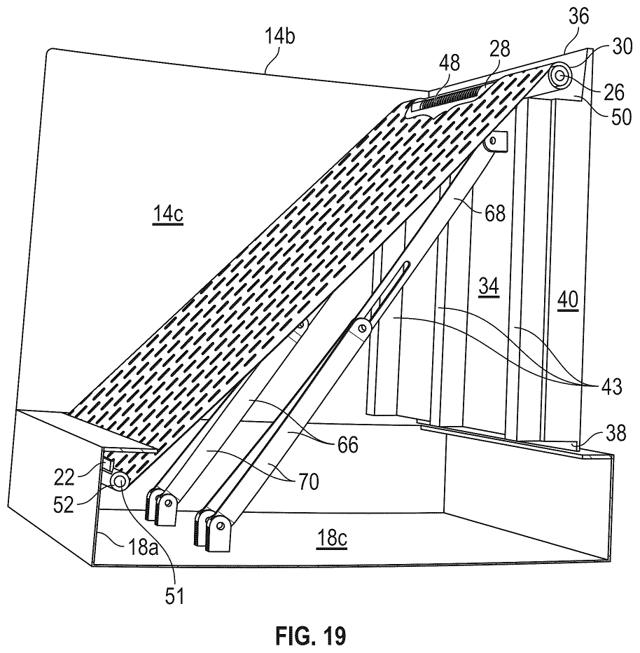

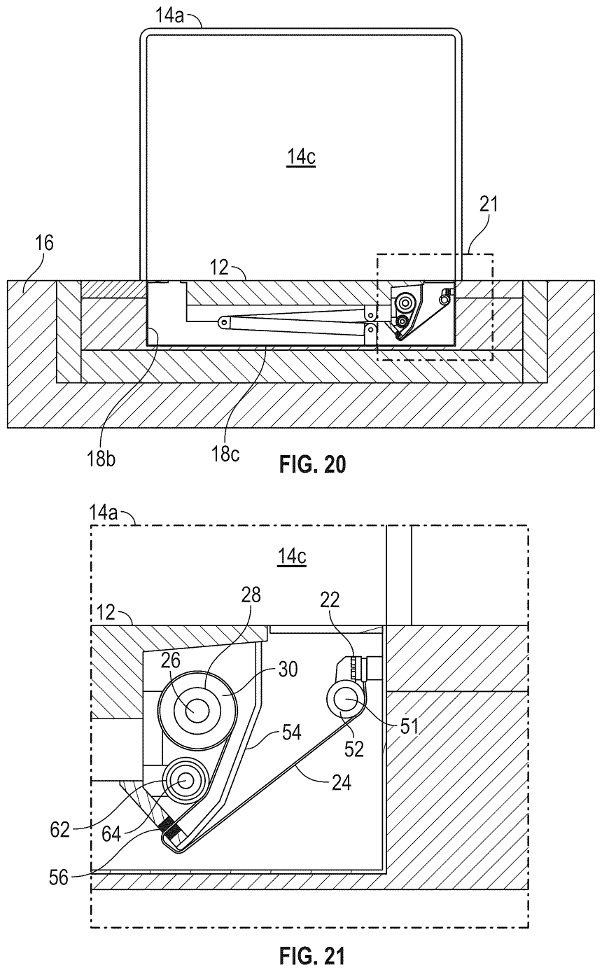

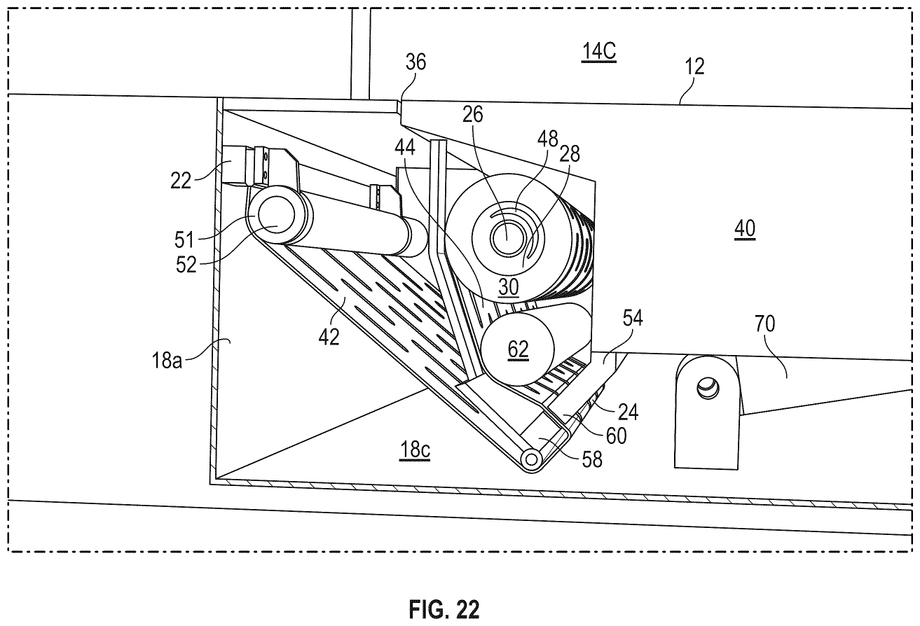

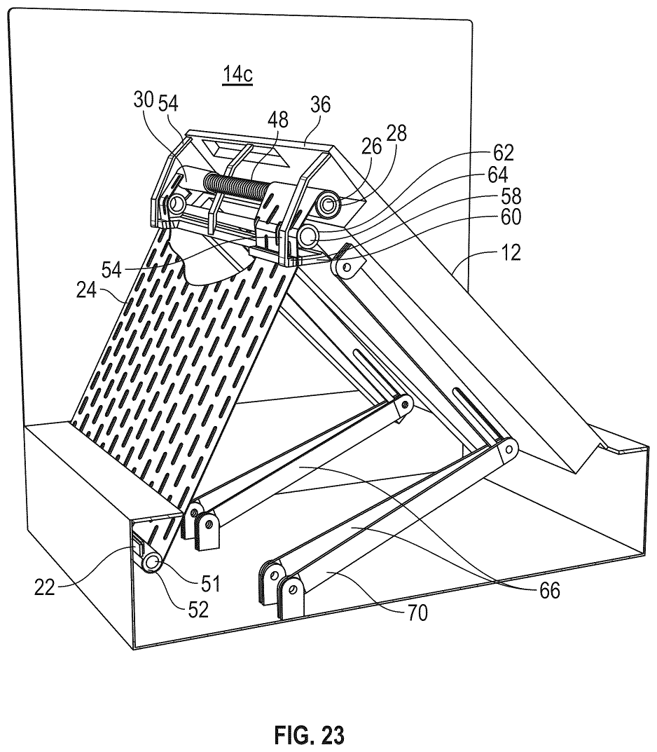

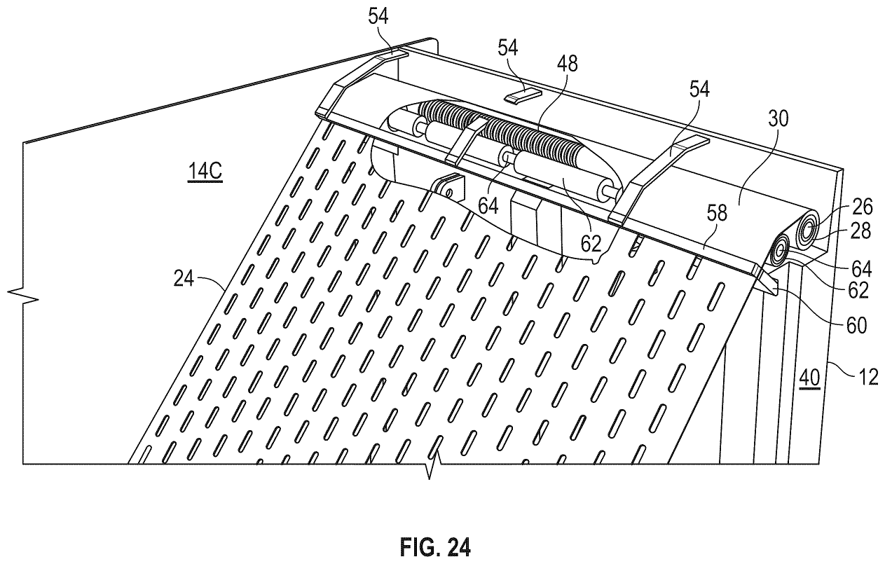

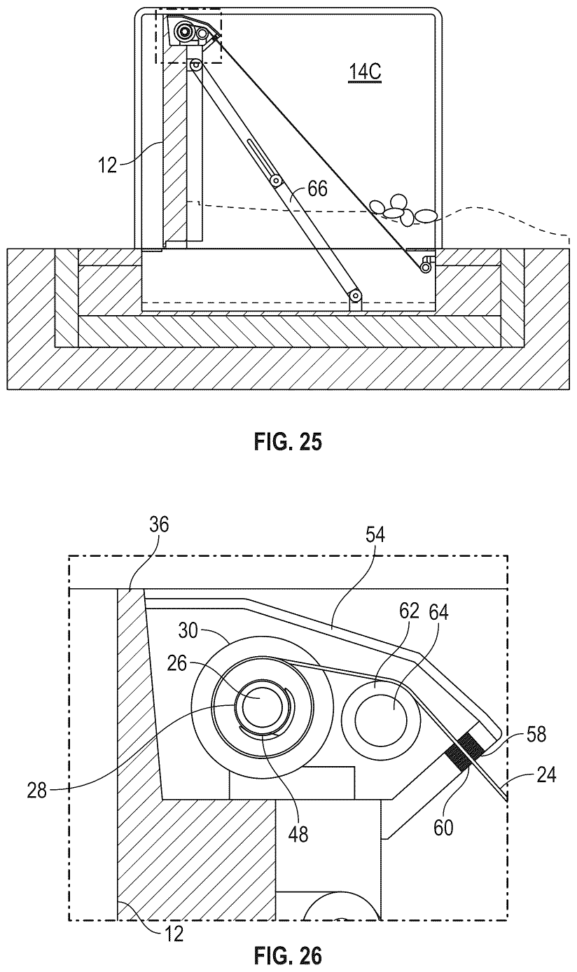

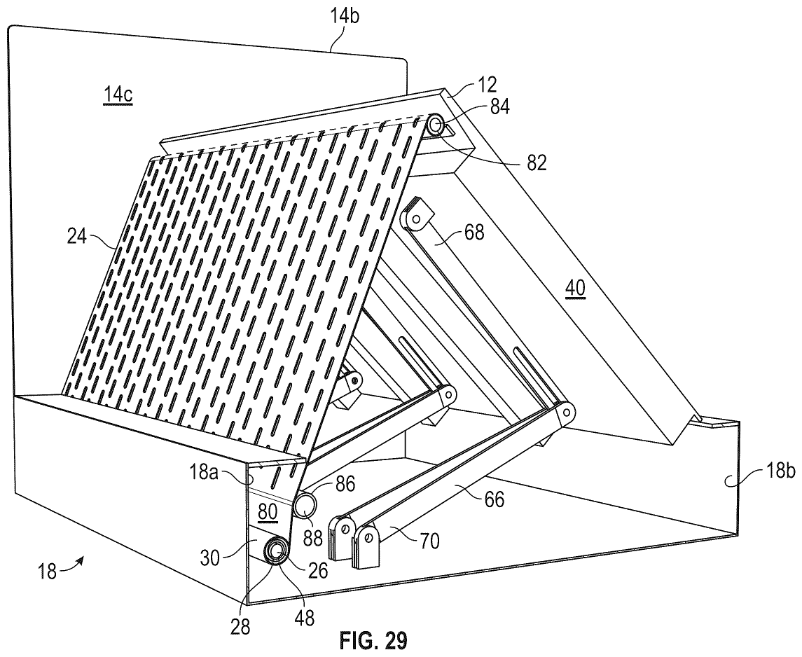

Referring to the Figures, four sets of drawings are provided. Sets one to three depict a basic configuration in which one end of a debris shield mesh is attached to a fixture on an interior front side of a support housing for a flip-up panel and the other end of the debris shield mesh is attached to a first roller rotating on a first horizontal axle mounted in an inset 50 of a front end of the flip-up panel. FIGS. 1-12 comprise the first set. A second set, FIGS. 13-19 show a stress relieving second roller mounted under the fixture in the front end of the housing, to which fixture one end of the debris shield mesh is attached. A third set, FIGS. 20-28 shows a support attached to the front end of the flip up panel with arms supporting a wiper having a width substantially the same as the width of the panel, the wiper having upper and lower brushes through which the debris shield mesh passes, the upper brush wiping the top side of the debris shield mesh and the lower brush wiping the underside of the debris shield mesh. FIGS. 20-28 also show a curved surface in the form of a third roller rotating on a third horizontal axle mounted in an inset 50 of the front end of the flip-up panel. FIG. 29 depicts a fourth configuration, which is an alternative to the first three sets. Unlike in FIGS. 1-28 in which the roller for unwrapping and wrapping the debris shield mesh is placed on an inset at the front end of the flip-up panel, FIG. 29 places the roller for unwrapping and wrapping the debris shield mesh on the inside of the front end of the support housing. FIG. 29 is a variation of the view as FIG. 18, both showing the panel partially rising out of the support housing. When FIG. 29 is discussed in detail below, the structures in FIG. 29 can be imagined moved to the same views as FIGS. 13-19 without burdening the description of the exemplary embodiment depicted in FIG. 29 with the redundancies of extra figures comparable to FIGS. 13-19.

Referring now to FIG. 1 of the first set of drawings, reference numeral 10 generally indicates a flood barrier assembly. The letter “A” indicates a wet side where flooding waters will enter, and the letter “B” indicates the side protected from flooding by flood barrier assembly 10.

Referring specifically to FIGS. 1-12 of the first set of drawings, assembly 10 comprises a substantially horizontal support housing 18 situated in or on foundation 16 on land. Support housing 18 has a front side 18a, a back side 18b and a bottom pan 18c. Assembly 10 includes a panel 12 that has a top surface 32, a bottom surface 34, a front end 36, a back end 38, and lateral sides 40 of a length that runs from the back end 38 to at least near the front end 36 of panel 12. Panel 12 includes rails 43 at the bottom surface to strengthen the panel. Panel 12 resides in the support housing 18 in a lowered position. The lateral sides 40 of panel 12 have an imagined projected intersecting angle to a waterway from which flooding waters can originate. The lateral sides 40 define between them the width of the panel 12. Panel 12 is hinged at the back end 38 of the panel to an interior of the back side 18b of support housing 18 to rotate upwardly from housing 18 to an upright raised position where invading flood water will be contained at the bottom surface 34 of panel 12.

Assembly 10 further includes a debris shield mesh 24 having mesh openings so porous as to allow water to flow freely through the mesh but not debris of a size larger than the mesh openings. Debris shield mesh 24 has, opposite ends and a width substantially as wide as the width of panel 12. One end of the debris shield mesh attaches to a fixture 22 on an interior of the front side 18a of support housing 18 and the other end of the debris shield mesh attaches to a first roller 28 rotating on a first horizontal axle 26 mounted in an inset 50 of the front end of the panel. Reference numeral 30 indicates debris shield mesh wrapped on a roller 28.

Assembly 10 further has self-winding means linked to the first horizontal axle 26, the self-winding means, suitably a torsion spring 48, winding up when panel 12 rotates upwardly to the upright raised position, the self-winding means exerting unwinding force in the opposite direction of winding up when panel 12 lowers to support housing 18. In an exemplary embodiment, torsion spring 48 coiled around first horizontal axle 26 twists about the axis of the coil when panel 12 rotates upwardly to the upright raised position. Torsion spring 48 exerts torque in the opposite direction of the twist when panel 12 lowers to the support housing 18. The self-winding means, suitably torsion spring 48, controls roll up and roll down of debris shield mesh 24 on first roller 28 when panel 12 rises and lowers, whereby debris shield mesh 24 is automatically deployed when panel 12 rises and is automatically retracted when panel 12 lowers.

Assembly 10 includes a plurality of retention members 66 having a top end 68 a bottom end 70. Top end 68 attaches to bottom surface 34 of panel 12 and bottom end 70 attaches to bottom pan 18c of support housing 18. Each retention member 66 is suitably folded in support housing 18 when panel 12 is recumbent in support housing 18. As panel 12 rotates upwardly out of support housing 20 retention members 66 unfold and extend upward to prevent panel 12 from rotating past an upright raised position.

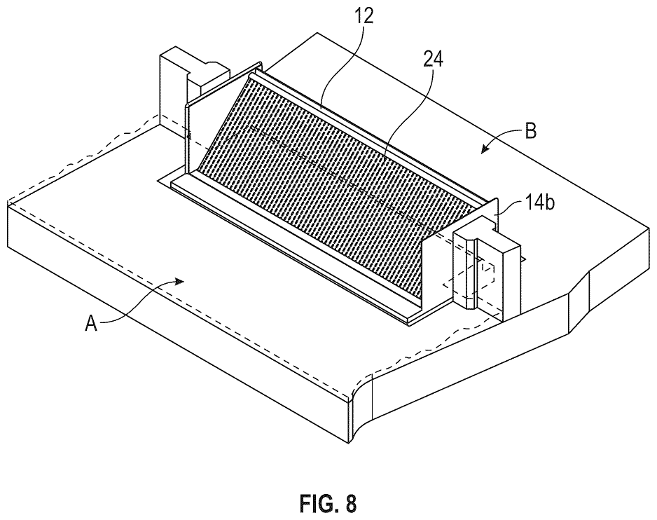

Assembly 10 operates with a pair of upright walls 14a and 14b braced by structural floodwalls 20. The floodwalls are seen in section in FIGS. 1 and 8. Each wall 14a and 14b is fixed atop horizontal support 18. Wall 14a is next adjacent one of the lateral sides 40 of panel 12. Wall 14b is next adjacent the other lateral side 40 of panel 12. Each wall 14a, 14b has a contact surface 14c as tall as the lateral sides 40 of the next adjacent panel 12 when panel 12 is in an upright raised position. The lateral side 40 of the panel next adjacent a wall 14a and the lateral side 40 of the panel next adjacent a wall 14b both attach a gasket for sealing contact with the contact surface 14c of the walls

Referring now to the second set of drawings, FIGS. 13-19, in FIG. 13 the same designation of the letters “A” and “B” are used as in FIG. 1 to indicate respectively the wet side and the dry side. The structure in the embodiments in FIGS. 13-19 that is the same as in the embodiments of FIGS. 1-12 is identified by the same reference numerals used in FIGS. 1-12. The difference between the embodiments in FIGS. 1-12 and the embodiments in FIGS. 13-19 is that in FIGS. 13-19 fixture 22 is a bracket and that a second roller 52 rotates under bracket 22 on a second horizontal axle 51 attached to bracket 22, debris shield mesh 24 passing under second roller 52 to aid in reducing any shearing of debris shield mesh 24 as the panel rotates upwardly from housing 18 to an upright raised position in which a substantial part 30 of the debris shield mesh is unwrapped around first roller 28.

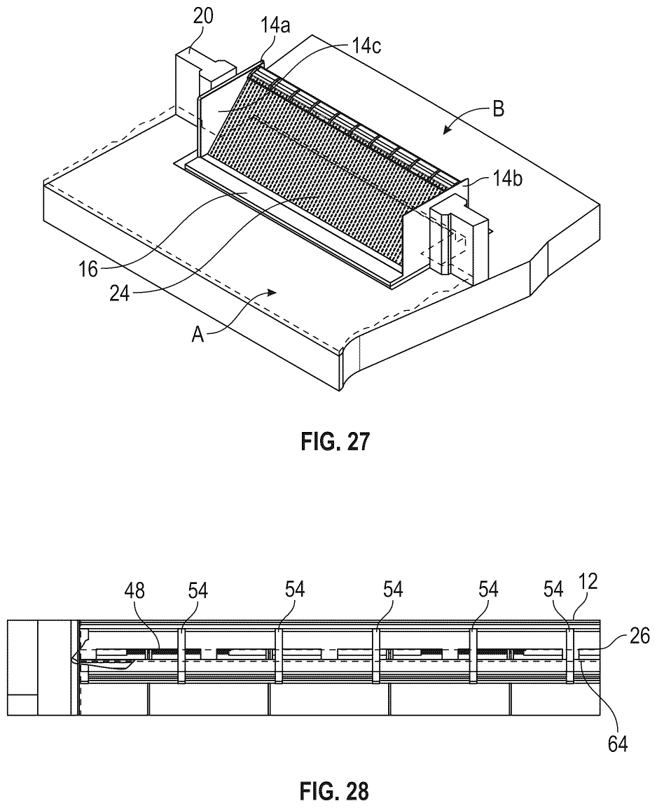

Referring now to the third set of drawings, FIGS. 20-28, the structures in the embodiments in FIGS. 20-28 that are the same as in the embodiments of FIGS. 13-19 are identified by the same reference numerals used in FIGS. 13-19. The main difference between the embodiments in FIGS. 13-19 and the embodiments in FIGS. 20-28 is that the embodiments in FIGS. 20-28 have a wiper support 54 attached to front end 36 of panel 12. Wiper support 54 supports a wiper 56 having a width substantially the same as the width of panel 12 for wiping debris off debris shield mesh 24 before debris shield mesh 24 is rewound onto first roller 28. Wiper 56 may be a scraper or a brush and suitably comprises an upper brush 58 and a lower brush 60. Debris shield mesh 24 passes between upper brush 58 and lower brush 60. Upper brush 58 wipes top side 42 of debris shield mesh 24 and lower brush 60 wipes the underside 44 of debris shield mesh 24. FIGS. 20-28 also depict a curved surface 62 having less elevation than first roller 28. Curved surface 62 also has a substantially similar length as first roller 28. Curved surface 62 is located between first roller 28 and wiper 56, suitably brushes 58, 60, to keep the width of debris shield mesh 24 centered between brushes 58, 60 regardless of the diameter of first roller 28 when it changes diameter as more or less debris shield mesh material is wrapped around it. Suitably, the curved surface is a cylindrical third roller 62 rotating on a third horizontal axle 64 affixed to wiper support 54. The third horizontal axle 64 has less elevation than second horizontal axle 51. In FIG. 27 the same designation of the letters “A” and “B” are used as in FIG. 1 to indicate respectively the wet side and the dry side.

Parts the same as like or analogous parts in the embodiments of FIGS. 1-28 have the same reference numbers in FIG. 29. The exemplary embodiment of FIG. 29 is similar to the exemplary embodiments of FIG. 1-28 except the roller 28, on which the debris shield mesh 24 unwraps as the panel 40 rises and wraps as the panel lowers, is placed on a horizontal axle 26 mounted in the interior of the front end 18a of the support housing 18. In FIG. 29, the lateral side of the support housing 18 is removed so internal structures can be viewed, and as in the comparable views of FIGS. 1-28 does not show the mounting structure for the roller axle 26. One end 80 of the debris shield mesh attaches to a roller 28 and the other end attaches to a fixture 82 over a stress easing cylinder 84. A second roller 86 on a second horizontal axle 88 is mounted to structure at removed lateral side of housing 18 also not shown but will be understood. Second roller 86 eases the stress on debris shield mesh 24 as panel 40 rises out of support housing 18 and unwraps debris shield mesh 24 from roller 28, and aids in alignment of debris shield mesh 24 as it wraps on roller 28 as panel 40 lowers to support housing 18. As in the embodiments of FIGS. 1-28, self-winding means are linked to the first horizontal axle 26, the self-winding means, suitably a torsion spring 48, winding up when panel 12 rotates upwardly to the upright raised position, pulling and unwrapping debris shield mesh 24 from roller 28, the self-winding means exerting unwinding force in the opposite direction of winding up when panel 12 lowers to support housing 18 pulling debris shield mesh 24 downward to wrap on roller 28. In an exemplary embodiment, torsion spring 48 coiled around first horizontal axle 26 twists about the axis of the coil when panel 12 rotates upwardly to the upright raised position. Torsion spring 48 exerts torque in the opposite direction of the twist when panel 12 lowers to the support housing 18. The self-winding means, suitably torsion spring 48, controls roll out and roll back of debris shield mesh 24 on first roller 28 when panel 12 rises and lowers, whereby debris shield mesh 24 is automatically deployed when panel 12 rises and is automatically retracted when panel 12 lowers.

The disclosed subject matter is to be considered illustrative, and not restrictive, and the appended claims are intended to cover all modifications, enhancements, and other embodiments that fall within the true scope of the present invention, which to the maximum extent allowed by law, is to be determined by the broadest permissible interpretation of the following claims and their equivalents, unrestricted or limited by the foregoing detailed descriptions of exemplary embodiments of the invention.

1. Apparatus comprising at least one flood barrier assembly arranged on land near a waterway, comprising:
a substantially horizontal support housing situated in or on the land and having a bottom pan and front, back and lateral sides,
a panel having a top surface, a bottom surface, a front end, a back end, and lateral sides of a length that runs from the back end to at least near the front end of the panel, the panel residing in the support housing in a lowered position in which the lateral sides having an imagined projected intersecting angle to the waterway, the lateral sides defining between them the width of the panel, the panel being hinged at the back end of the panel to an interior of the back side of the support housing to rotate upwardly from the housing to an upright raised position where invading flood water will be contained at the bottom surface of the panel, and
a debris shield mesh having mesh openings so porous as to allow water to flow freely through the mesh openings but not debris of a size larger than the mesh openings, the debris shield mesh having a top side and an underside, opposite ends and a lateral width substantially as wide as the width of the panel, in a first instance one end of the debris shield mesh attaching to a fixture in an interior of the front side of the support housing, said fixture having substantially the same width as the debris shield mesh, and the opposite end of the debris shield mesh attaching to a roller rotating on a horizontal axle mounted in a interior of the front end of the panel, and in an alternative second instance, one end of the debris shield mesh attaching to a roller rotating on a horizontal axle mounted in the interior of the front end of the housing, said roller having substantially the same width as the debris shield mesh, and the opposite end of the debris shield mesh attaching to a fixture at the front end of the panel, this fixture having substantially the same width as the debris shield mesh.

2. The apparatus of claim 1 further comprising, in either said instances, self-winding means linked to the horizontal axle, said self-winding means winding up when the panel rotates upwardly to the upright raised position, said self-winding means exerting unwinding force in the opposite direction of winding up when the panel lowers to the support housing, the self-winding means controlling unwrapping and wrapping of the debris shield mesh on the roller when the panel rises and lowers, whereby the debris shield mesh is automatically deployed when the panel rises and is automatically retracted when the panel lowers.

3. The apparatus of claim 2 in which the self-winding means comprises a torsion spring coiled around the horizontal axle and that twists about the axis of the coil when the panel rotates upwardly to the upright raised position, the torsion spring exerting torque in the opposite direction of the twist when the panel lowers to the support housing.

4. The apparatus of claim 1 of said first instance, in which said fixture is a bracket on an interior of the front side of the support housing and said roller is a first roller that rotates on a first horizontal axle mounted in the interior of the front end of said panel, further comprising a second roller rotating under said bracket on a second horizontal axle attached to said bracket, said debris shield mesh passing under said second roller to aid in reducing any shearing of the debris shield mesh as the panel rotates upwardly from the housing to an upright raised position unwrapping a substantial part of the debris shield mesh from said first roller.

5. The apparatus of claim 4 further comprising a wiper support attached to the front end of the panel, said support supporting a wiper having a width substantially the same as the width of the panel for wiping debris off the debris shield mesh before the debris shield mesh is rewound onto the first roller.

6. The apparatus of claim 5 in which the wiper is a scraper.

7. The apparatus of claim 5 in which the wiper is a brush.

8. The apparatus of claim 7 in which said wiper comprises upper and lower brushes through which the debris shield mesh passes, the upper brush wiping said top side of the debris shield mesh and the lower brush wiping said underside of the debris shield mesh.

9. The apparatus of claim 8 further comprising a curved surface having a substantially similar length as said first roller, the curved surface being located between said wiper and said first roller to keep the width of the debris shield mesh centered between the brushes regardless of the diameter of said first roller when it changes diameter as more or less debris shield mesh material wraps or unwraps around it.

10. The apparatus of claim 9 in which said curved surface is a third roller rotating on a third horizontal axle mounted at an interior of the front end of the panel under said first roller.

11. The apparatus of claim 1 in the which panel is buoyant and which the support housing allows invading water to enter the housing to buoy the panel upwardly out of the housing.

12. The apparatus of claim 1 in which the panel is mechanically raisable upwardly out of the housing.

13. The apparatus of claim 12 in which the panel also is buoyant and which the support housing allows invading water to enter the housing to buoy the panel upwardly out of the housing.

14. The apparatus of claim 1 further comprising a plurality of retention members having top and bottom ends, the top end attaching to the bottom surface of said panel and the bottom end attaching to said support pan, each retention member extending as the panel rotates upwardly out of the support housing to prevent the panel from rotating past the upright raised position.

15. The apparatus of claim 14 further comprising a pair of upright walls, each fixed next adjacent a lateral side of said panel, each wall having a contact surface as tall as said lateral side of the adjacent panel when the panel is in the upright raised position, said lateral side of the panel next adjacent a wall attaching a gasket for sealing contact with the contact surface of the wall.

16. The apparatus of clam 1 comprising a plurality of panels recumbent in a said support housing between upright walls, said panels on rotation out of the housing to an upright raised position forming a continuous barrier against rising waters flooding land beyond the top surfaces of the panels.
